(19) United States
(12) Patent Application Publication
(10) Pub. No.: US 2016/0195743 A1
(43) Pub. Date: Jul. 7, 2016

(54) LIQUID CRYSTAL DISPLAY

(71) Applicant: Samsung Display Co., Ltd., Yongin-City (KR)

(72) Inventors: Han Su KIM, Seoul (KR); Seung-Yeon CHAE, Hwaseong-si (KR); Se Hee HAN, Seoul (KR)

(21) Appl. No.: 14/748,025

(22) Filed: Jun. 23, 2015

(30) Foreign Application Priority Data
Jan. 7, 2015 (KR) 10-2015-0001986

(51) Int. Cl. G02F 1/1337; G02F 1/1335; G02F 1/1341; G02F 1/1368; G02F 1/1333

(52) U.S. Cl. CPC G02F 1/1337; G02F 1/1368; G02F 1/133377; G02F 1/1341; G02F 1/133345; G02F 1/133512; G02F 1/133514

(57) ABSTRACT

A liquid crystal display includes a substrate, a thin film transistor disposed on the substrate, a pixel electrode disposed on the thin film transistor and connected to the thin film transistor, an alignment layer disposed on the pixel electrode and within a microcavity having an injection hole, a liquid crystal layer disposed within the microcavity, and a roof layer disposed on the microcavity, the roof layer having an opening.

### CROSS-REFERENCE TO RELATED APPLICATION

This application claims priority to and the benefit of Korean Patent Application No. 10-2015-0001986 filed in the Korean Intellectual Property Office on Jan. 7, 2015, the entire contents of which are incorporated herein by reference.

### BACKGROUND

(a) Technical Field

The present disclosure generally relates to a liquid crystal display.

(b) Description of the Related Art

A liquid crystal display (LCD) is one of the most commonly used display devices. The liquid crystal display typically includes a liquid crystal display panel in which a liquid crystal layer is disposed between a lower panel and an upper panel. A voltage is applied to a pixel electrode and a common electrode of the liquid crystal panel to generate an electric field. The electric field realigns an arrangement of liquid crystal molecules in the liquid crystal layer and controls polarization of incident light passing through the liquid crystal layer, thereby displaying images.

The liquid crystal display panel of the liquid crystal display may include the lower panel and the upper panel facing the lower panel. Thin film transistors may be disposed on the lower panel. A gate line for transmitting a gate signal, a data line for transmitting a data signal, a thin film transistor connected to the gate line and the data line, and a pixel electrode connected to the thin film transistor may be formed in the lower panel. A light blocking member, a color filter, and a common electrode may be formed in the upper panel. In some cases, at least one of the above elements in the upper panel may be formed in the lower panel instead of the upper panel.

In general, two substrates are used for the lower panel and the upper panel of the liquid crystal display, and processes for forming the above-described constituent elements in each panel and combining the two panels are required. As a result, the liquid crystal panel is often heavy, has a thick form factor, and high manufacturing cost and lead-time are incurred.

In recent years, a technique has been developed to address the above issues. The technique involves forming a plurality of microcavities of a tunnel shape structure on a substrate and injecting a liquid crystal into the structure to manufacture the display device. During the manufacture of the liquid crystal display, a solution is injected into the microcavities and dried to form the alignment layer before injecting the liquid crystal into the microcavities. The solution includes a solvent in which a material for forming an alignment layer dissolved. In some instances, during the process of drying the solution, solids may agglomerate into lumps, which may subsequently cause light leakage or transmittance deterioration.

The above information disclosed in this Background section is to enhance understanding of the background of the inventive concept and therefore it may contain information that does not form the prior art that is already known in this country to a person of ordinary skill in the art.

### SUMMARY

The present disclosure addresses at least the above issues in the prior art.

According to an exemplary embodiment of the inventive concept, a liquid crystal display is provided. The liquid crystal display includes: a substrate; a thin film transistor disposed on the substrate; a pixel electrode disposed on the thin film transistor and connected to the thin film transistor; an alignment layer disposed on the pixel electrode and within a microcavity having an injection hole; a liquid crystal layer disposed within the microcavity; and a roof layer disposed on the microcavity, the roof layer having an opening.

In some embodiments, the alignment layer may be formed from an alignment layer forming material, and the alignment layer forming material may aggregate on at least a portion of the opening.

In some embodiments, the liquid crystal display may further include a partition wall disposed between adjacent microcavities, wherein the opening is adjacent to the partition wall.

In some embodiments, the opening may overlap with the partition wall.

In some embodiments, the opening may be connected to two adjacent microcavities.

In some embodiments, a top surface of the partition wall that overlaps with the opening may have a flat shape.

In some embodiments, t top surface of the partition wall that overlaps with the opening may have an uneven shape.

In some embodiments, the liquid crystal display may further include a common electrode configured to generate an electric field together with the pixel electrode.

In some embodiments, the common electrode may be disposed between the microcavity and the roof layer.

In some embodiments, the common electrode may be disposed above or below the pixel electrode, with an insulating layer disposed therebetween.

In some embodiments, the roof layer may include a plurality of openings for one microcavity.

In some embodiments, an alignment layer forming material may be disposed on the partition wall.

In some embodiments, the partition wall may include a light blocking member.

In some embodiments, the partition wall may include a color filter.

In some embodiments, the roof layer may include a color filter.

In some embodiments, the liquid crystal display may further include a capping layer disposed on the roof layer.

In some embodiments, the alignment layer may be formed from an alignment layer forming material, the alignment layer forming material may aggregate on at least a portion of the opening, and the capping layer may contact the alignment layer forming material.

In some embodiments, the capping layer may contact the partition wall.

### BRIEF DESCRIPTION OF THE DRAWINGS

FIG. 1 is a top plan view of a display device according to an exemplary embodiment.

FIG. 2 is a cross-sectional view taken along line II-II of FIG. 1.

FIG. 3 is a cross-sectional view taken along line III-III of FIG. 1.

FIG. 4 is a cross-sectional view taken along line IV-IV of FIG. 1.

FIGS. 5(a) and 6(a) illustrate cases in which a material for forming an alignment layer remains on a roof layer.

FIGS. 5(b) and 6(b) illustrate cases in which a material for forming an alignment layer does not remain on a roof layer.

FIG. 7 is a cross-sectional view of a display device according to another exemplary embodiment corresponding to a cross-section similar to that taken along line III-III of FIG. 1.

FIG. 8 is a cross-sectional view of a display device according to a further exemplary embodiment corresponding to a cross-section similar to that taken along line IV-IV of FIG. 1.

FIGS. 9, 10, 11, 12, 13, 14, 15, 16, 17, 18, 19, 20, 21, 22, and 23 are cross-sectional views of a liquid crystal display at different stages of manufacture according to an exemplary method of manufacturing the liquid crystal display.

### DETAILED DESCRIPTION

The inventive concept will be described more fully herein with reference to the accompanying drawings in which exemplary embodiments are shown. As those skilled in the art would realize, the embodiments may be modified in various ways without departing from the spirit or scope of the present disclosure.

In the drawings, the thickness of layers, films, panels, regions, etc., may be exaggerated for clarity. It will be understood that when an element such as a layer, film, region, or substrate is referred to as being “on” another element, it can be directly on the other element, or with one or more intervening elements being present. In contrast, when an element is referred to as being “directly on” another element, there are no intervening elements present. In this specification, unless otherwise indicated, “overlapping” means overlapping when viewed in a plan view.

A liquid crystal display according to exemplary embodiments of the inventive concept will be described with reference to the accompanying figures.

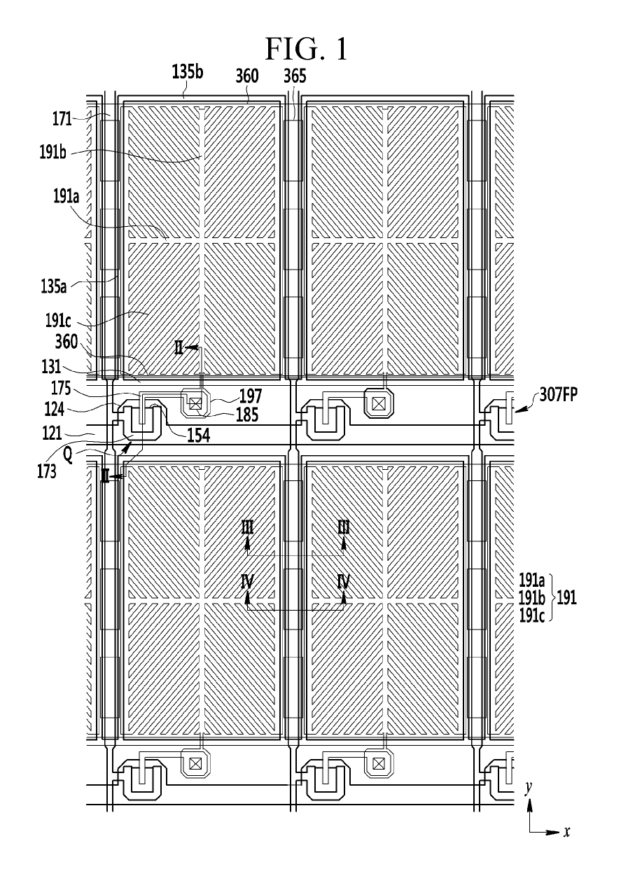

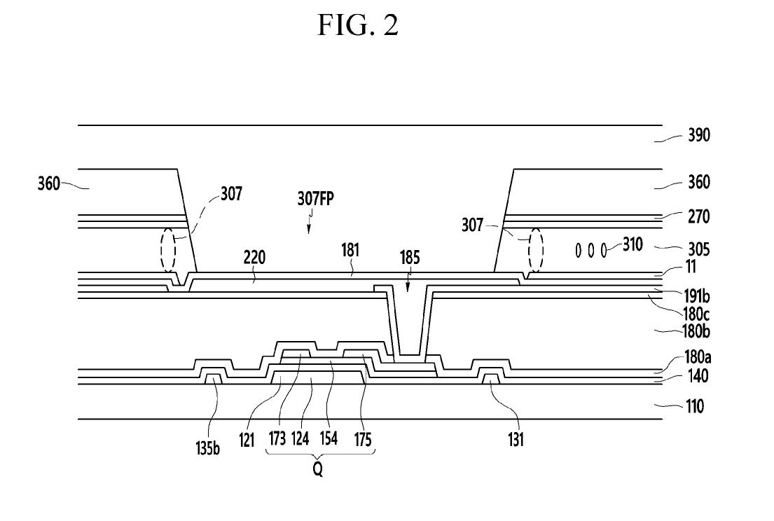

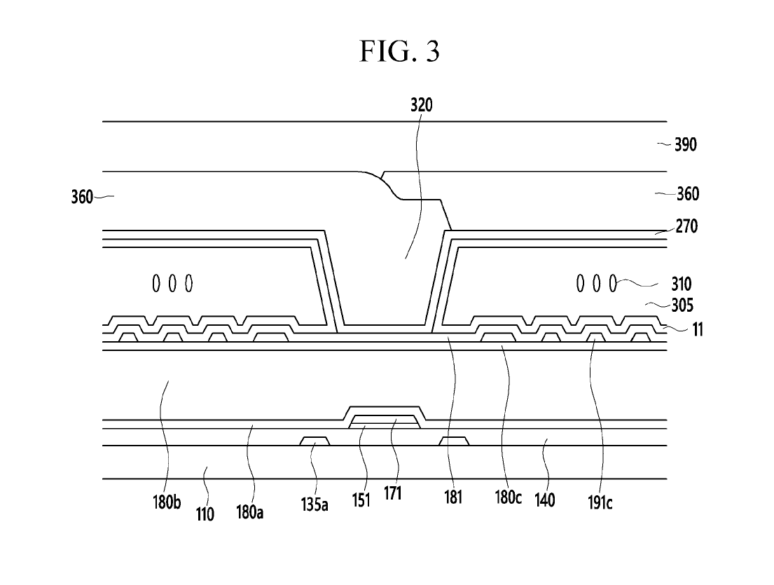

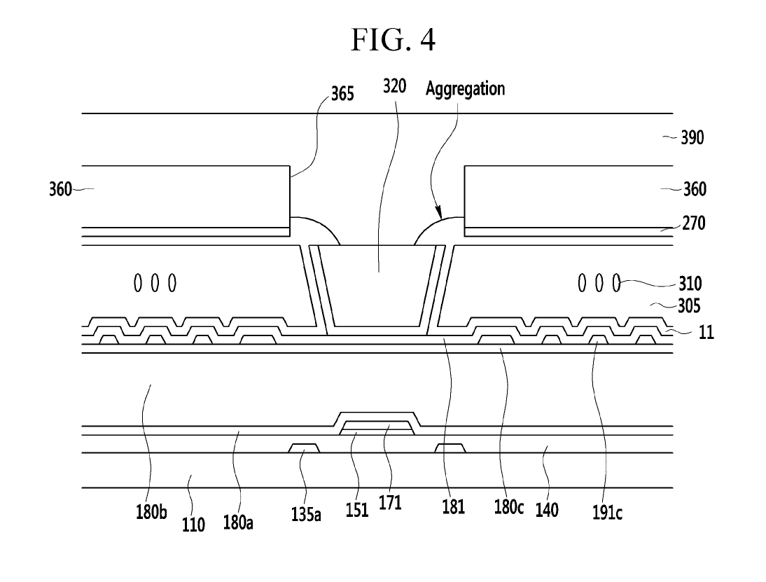

FIG. 1 is a top plan view of a display device according to an exemplary embodiment, FIG. 2 is a cross-sectional view taken along line II-II of FIG. 1, FIG. 3 is a cross-sectional view taken along line III-III of FIG. 1, and FIG. 4 is a cross-sectional view taken along line IV-IV of FIG. 1.

FIG. 1 illustrates four adjacent pixel areas among a plurality of pixels arranged in a matrix form.

Referring to FIGS. 1, 2, 3, and 4, a gate conductor is formed on a substrate 110. The gate conductor includes a gate line 121 and a storage electrode line 131. The substrate 110 may be made of a transparent insulator such as glass or plastic.

The gate line 121 is configured to transmit a gate signal and extends in a substantially horizontal direction. The gate line 121 includes a gate electrode 124 protruding from the gate line 121. It is noted that a protruding portion of the gate electrode 124 may be provided in different configurations.

The storage electrode line 131 is configured to transfer a predetermined voltage such as a common voltage Vcom. The storage electrode line 131 extends in a substantially horizontal direction. The storage electrode line 131 includes a pair of vertical portions 135a extending substantially perpendicular to the gate line 121, and a horizontal portion 135b connecting ends of the pair of vertical portions 135a. The vertical portions 135a and the horizontal portion 135b of the storage electrode line 131 may substantially surround a pixel electrode 191.

A gate insulating layer 140 is formed on the gate line 121 and the storage electrode line 131. The gate insulating layer 140 may be made of an inorganic insulating material such as a silicon nitride (SiNx) or a silicon oxide (SiOx). The gate insulating layer 140 may be formed as a single layer or a multilayer structure.

A semiconductor 151 and a semiconductor 154 are formed on the gate insulating layer 140. Specifically, the semiconductor 151 is disposed below a data line 171, and the semiconductor 154 is disposed below source and drain electrodes and at a channel portion of a thin film transistor Q. The semiconductors 151 and 154 may be made of amorphous silicon, polycrystalline silicon, a metal oxide, and the like.

An ohmic contact (not illustrated) may be formed among the semiconductors 151 and 154, the data line 171, and the source and drain electrodes. The ohmic contact may be made of a silicide, or a material such as n+ hydrogenated amorphous silicon in which an n-type impurity is doped at a high concentration.

A data conductor is formed on the semiconductors 151 and 154 and the gate insulating layer 140. The data conductor includes a source electrode 173, a drain electrode 175, and the data line 171 connected with the source electrode 173.

The data line 171 is configured to transfer a data signal and extends in a substantially vertical direction crossing the gate line 121. The source electrode 173 and the drain electrode 175, together with the gate electrode 124 and the semiconductor 154, collectively constitute the thin film transistor Q. A channel of the thin film transistor Q is formed in the semiconductor 154 between the source electrode 173 and the drain electrode 175.

A first interlayer insulating layer 180a is formed on the data conductor (data line 171, source electrode 173, and drain electrode 175) and an exposed portion of the semiconductor 154. The first insulating layer 180a may include an inorganic insulating material such as a silicon nitride (SiNx) or a silicon oxide (SiOx).

A second interlayer insulating layer 180b and a third interlayer insulating layer 180c may be disposed on the first interlayer insulating layer 180a. The second interlayer insulating layer 180b may be formed of the organic material, and the third interlayer insulating layer 180c may include the inorganic insulating material such as the silicon nitride (SiNx) or the silicon oxide (SiOx). In some embodiments, the second interlayer insulating layer 180b may be formed of the organic material instead of the inorganic insulating material, which can reduce a process step. In some particular embodiments, one or more of the first interlayer insulating layer 180a, second interlayer insulating layer 180b, and third interlayer insulating layer 180c may be omitted.

The pixel electrode 191 is formed on the third interlayer insulating layer 180c. The pixel electrode 191 may be made of a transparent conductive material such as indium tin oxide (ITO) or indium zinc oxide (IZO).

The pixel electrode 191 may have a substantially quadrangular shape. The pixel electrode 191 may include a cross-shaped stem having a horizontal stem 191a and a vertical stem 191b crossing the horizontal stem 191a. The pixel electrode 191 may be divided into four subregions by the horizontal stem 191a and the vertical stem 191b, and each subregion includes a plurality of minute branches 191c. The pixel electrode 191 may further include an outer stem surrounding an outer circumference thereof.

The minute branches 191c of the pixel electrode 191 may form an angle of approximately 40° to 45° with the gate line 121 or the horizontal stem 191a. The minute branches 191c of two adjacent subregions may be orthogonal to each other. A width of the minute branches may be gradually increased, or a distance between the minute branches 191c may vary.

The pixel electrode 191 includes an extension 197 connected to a lower end of the vertical stem 191b. The extension 197 may have a larger area than the vertical stem 191b. The extension 197 of the pixel electrode 191 is physically and electrically connected to the drain electrode 175 through contact holes 185 formed in the first interlayer insulating layer 180a, second interlayer insulating layer 180b, and third interlayer insulating layer 180c. The pixel electrode 191 is configured to receive a data voltage from the drain electrode 175.

It is noted that the above configuration/structure of the thin film transistor Q and pixel electrode 191 is merely exemplary, and that the structure of the thin film transistor and configuration of the pixel electrode may be modified in differents ways to improve side visibility.

A light blocking member 220 is disposed on the pixel electrode 191 covering a region where the thin film transistor Q is formed. The light blocking member 220 may be formed along a direction in which the gate line 121 extends. In some other embodiments, the light blocking member 220 may be formed in a direction in which the data line 171 extends, and thus the light blocking member 220 may have a lattice structure including an opening corresponding to a light-emitting region for displaying an image (i.e., a pixel area). The light blocking member 220 may be made of a material that does not allow light to pass through.

An insulating layer 181 may be formed on the light blocking member 220 covering the light blocking member 220. The insulating layer 181 may extend onto the pixel electrode 191.

A microcavity 305 is formed on the pixel electrode 191. The microcavity 305 is a space that is formed when a sacrificial layer is formed and then removed. The microcavity 305 may be formed in a pixel area. In some embodiments, the microcavity 305 may be formed over two adjacent pixel areas. The microcavity 305 has an injection hole 307 through which a liquid crystal including liquid crystal molecules 310 is injected. A liquid crystal layer is formed inside the microcavity 305. The liquid crystal may be injected into the microcavity 305 through the injection hole 307 using capillary force. A material for forming an alignment layer 11 may also be injected into the microcavity 305 through the injection hole 307 using capillary force, prior to injecting the liquid crystal.

Although the drawings illustrate the injection hole 307 being formed on opposite facing edges of microcavities 305 that are adjacently formed in the vertical direction, the inventive concept is not limited thereto. In some other embodiments, the injection hole 307 may be formed on only one of the two opposite facing edges of the microcavities 305.

The plurality of microcavities 305 are formed in a matrix shape. The microcavities 305 may be divided in a horizontal direction by a partition wall 320, and may be divided in a vertical direction by an injection hole formation region 307FP (also referred to as trenches). In other words, one microcavity 305 may be formed at a region defined by an adjacent partition wall 320 and an adjacent injection hole formation region 307FP. Each microcavity 305 may correspond to one or more pixel areas.

The alignment layer 11 is formed on an internal surface of the microcavity 305. The alignment layer 11 is a liquid crystal alignment layer, and may include at least one of commonly-used alignment materials. For example, the alignment layer 11 may include an alignment layer forming material such as polyamic acid, polysiloxane, or polyimide. In some embodiments, the alignment layer 11 may be a photo-alignment layer.

A common electrode 270 is disposed on the alignment layer 11. The common electrode 270 is configured to receive a common voltage and generate an electric field together with the pixel electrode 191 to which a data voltage is applied. The electric field determines tilt directions of the liquid crystal molecules 310 disposed in the microcavity 305 between the two electrodes. The common electrode 270 and the pixel electrode 191 collectively constitute a capacitor that maintains the applied voltage even after the thin film transistor is turned off.

In the present exemplary embodiment, the common electrode 270 is formed on the microcavity 305. However, the inventive concept is not limited thereto. In some other embodiments, the common electrode 270 may be formed at a lower portion of the microcavity 305 or below the microcavity 305. For example, the common electrode 270 may be formed in the same layer as the pixel electrode 191 at an interval such that the common electrode 270 is electrically separated from the pixel electrode 191, in order to generate a horizontal electric field with the pixel electrode 191. The common electrode 270 may be formed above or below the pixel electrode 191, with an insulating layer disposed therebetween.

A roof layer 360 is disposed on the common electrode 270. The roof layer 360 allows the microcavity 305, which is a space between the pixel electrode 191 and the common electrode 270, to be formed. The roof layer 360 may be made of a color filter.

The color filter in the roof layer 360 may be configured to display one of three primary colors such as red, green, and blue. However, the color filter is not limited to displaying the three primary colors such as red, green, and blue. In some other embodiments, the color filter may be configured to display at least one of cyan, magenta, yellow, and white-based colors.

The color filter is formed of materials that display different colors for each adjacent pixel. As shown in FIG. 3, one of adjacent color filters constitutes the partition wall 320. For example, a blue color filter may constitute the partition wall 320. Accordingly, the partition wall 320 may be made of the same material as the roof layer 360, and may be covered by the roof layer 360. The partition wall 320 is disposed between the microcavities 305 that are adjacent in the horizontal direction, so as to fill a gap between the adjacent microcavities 305. Accordingly, the microcavity 305 may be defined by the partition wall 320. The partition wall 320 may be formed along a direction in which the data line 171 extends. Adjacent color filters may overlap with each other on the partition wall 320. An interface of the adjacent color filters may be positioned corresponding to the partition wall 320. When the partition wall 320 includes the color filter, a light blocking member (not shown) may be formed overlapping the partition wall 320 between the insulating layer 181 and the third interlayer insulating layer 180c.

In some other embodiments, the roof layer 360 may be made of a photoresist or another organic material instead of the color filter. In those other embodiments, the color filter may be formed directly on the first interlayer insulating layer 180a. An insulating layer may be disposed between the common electrode 270 and the roof layer 360. The insulating layer may be made of an inorganic material such as a silicon nitride (SiNx) or a silicon oxide (SiOx).

Referring to FIGS. 1 and 4, an opening 365 may be formed in the roof layer 360. The opening 365 is connected to the microcavity 305 and allows an alignment layer forming material to be injected into the microcavity 305. The microcavity 305 is substantially covered by the roof layer 360 except at an upper portion exposed by the opening 365. The common electrode 270 may be removed at the region where the opening 365 is formed. The opening 365 may be formed as a slit (e.g., a slit having a width of about 1 micrometer) along an upper edge of the microcavity 305. The opening 365 (that is connected to the microcavity 305) may be at least partially filled with the alignment layer forming material after the alignment layer 11 is formed.

The opening 365 is disposed close to the partition wall 320. For example, as shown in the drawings, the opening 365 may be formed by partially removing the roof layer 360, so that the opening 365 is connected to the microcavities 305 disposed at opposite sides of the partition wall 320. A horizontal width of the opening 365 may vary according to a width of the partition wall 320. For example, the horizontal width of the opening 365 may be in a range of several micrometers. A plurality of openings 365 may be formed along the partition wall 320 for a pair of adjacent microcavities 305. For example, in an embodiment in which three openings are formed along the partition wall 320, a microcavity 305 may be connected to a total of six openings 365 at opposite sides. When a plurality of openings 365 are formed for the pair of adjacent microcavities 305, the roof layer 360 is prevented from drooping, compared to an embodiment in which only one opening 365 is longitudinally formed in the vertical direction.

The alignment layer forming material that is injected through the injection hole 307 is agglomerated at the opening 365. A solution in which the alignment layer forming material is dissolved in a solvent is provided. The solution is then injected into the microcavity 305. In a drying process for forming the alignment layer, some of the solution may aggregate near the partition wall 320 by capillary force and then aggregate in the opening 365. In other words, when the solution is guided by a relatively large capillary force to the opening 365 and then dried, a residue of the alignment layer forming material aggregates in the opening 365. The opening 365 is disposed near the partition wall 320. Accordingly, although the aggregation of the alignment layer forming material is generated in the opening 365, the opening 365 nevertheless corresponds to a boundary of the pixel area. Thus, defects such as light leakage or texture due to aggregation is prevented or minimized.

According to the exemplary embodiment, the aggregation of the alignment layer forming material can be controlled such that the aggregation is generated in the opening 365 formed in the roof layer 360. As a result, the aggregation of the alignment layer forming material is prevented from being generated within the microcavity 305 or the injection hole 307. Accordingly, a supporting element for preventing the roof layer 360 from drooping caused by the aggregation of the alignment layer forming material need not be formed. If the supporting element were formed, light leakage would be generated around the supporting element, and thus the light blocking member 220 has to be formed extending up to the supporting element. However, the exemplary embodiment does not require the supporting element to be formed and as a result, the aperture ratio can be increased.

In some cases, when the solution of the alignment layer forming material is injected into the roof layer 360, the solution may drop onto the roof layer 360. In those cases, a drop of the solution that is dried on the roof layer 360 may be seen as a spot. However, according to the exemplary embodiment, since the opening 365 is formed in the roof layer 360, the solution on the roof layer 360 may be aggregated by the opening 365. Accordingly, the alignment layer forming material remaining on the roof layer 360 can be removed or minimized. During the injection of the liquid crystal, the liquid crystal is also aggregated by the opening 365 which prevents the liquid crystal from remaining on the roof layer 360.

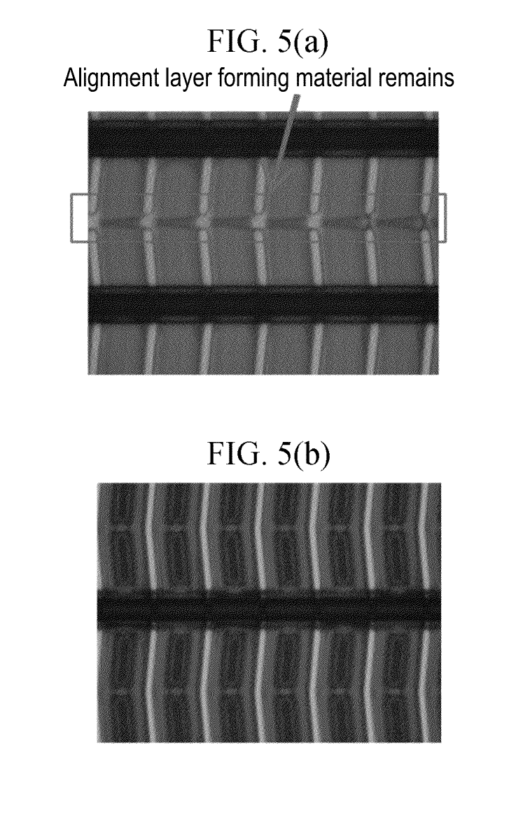

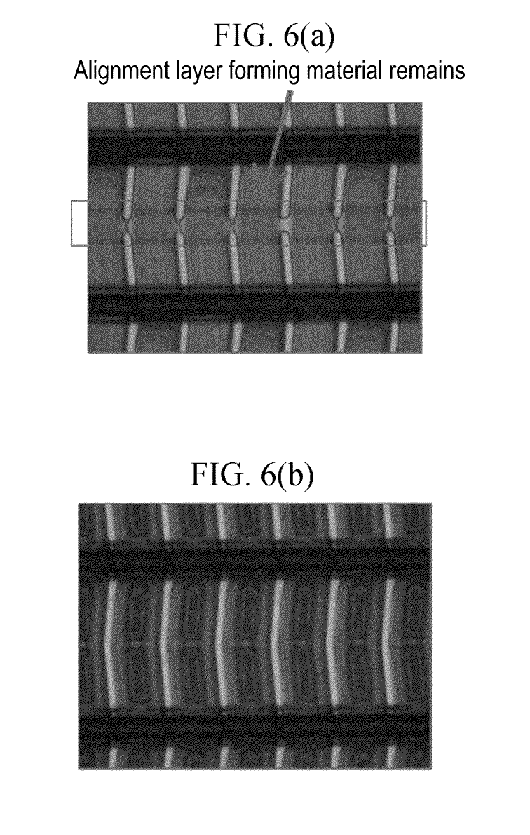

FIGS. 5(a) and 5(b) illustrates test results for which a solution of an alignment layer forming material is applied under a 120% condition (i.e. 20% more solution is applied to a roof layer than necessary). FIG. 6 illustrates test results for which a solution of the alignment layer forming material is applied under a 300% condition (i.e. 200% more solution is applied to a roof layer than necessary). Specifically, FIGS. 5(a) and 6(a) correspond to a first case in which no opening 365 is formed in the roof layer 360, and FIGS. 5(b) and 6(b) correspond to a second case in which the opening 365 is formed in the roof layer 360. In the first case in which no opening 365 is formed in the roof layer 360, the alignment layer forming material remains on the roof layer 360, as shown in FIGS. 5(a) and 6(a). In contrast, in the second case in which the opening 365 is formed in the roof layer 360, no alignment layer forming material remains on the roof layer 360, as shown in FIGS. 5(b) and 6(b).

When the alignment layer forming material is injected into the microcavity 305, air inside the microcavity 305 may escape through the opening 365, thereby allowing the alignment layer forming material to be smoothly injected and more uniform formation of the alignment layer 11. Since the opening 365 connected to the microcavity 305 is not filled by the alignment layer forming material, the air inside the microcavity 305 can escape during the injection of the liquid crystal, and thus there are no bubbles in the liquid crystal within the microcavity 305 after the liquid crystal is injected.

A capping layer 390 is disposed on the roof layer 360 and the partition wall 320. The capping layer 390 is disposed in the liquid crystal injection hole formation region 307FP. The liquid crystal injection hole formation region 307FP is disposed corresponding to a space formed between the microcavities that are adjacent to each other in the vertical direction. The capping layer 390 is formed covering the liquid crystal injection hole 307 of the microcavity 305 that is exposed by the liquid crystal injection hole formation region 307FP. The capping layer 390 may be formed by coating and hardening a liquid capping layer forming material. The capping layer 390 may contact the alignment layer forming material aggregating in the opening 365 of the roof layer 360, and may contact the partition wall 320.

The capping layer 390 includes an organic material. In some other embodiments, the capping layer 390 may include an inorganic material. The capping layer 390 may be formed as a multilayer structure such as a double layer or a triple layer structure. The double layer structure includes two layers made of different materials. The triple layer structure includes three layers, and materials of adjacent layers are different from each other. For example, the capping layer 390 may include a layer made of an organic insulating material and a layer made of an inorganic insulating material. In some embodiments, an insulating layer may be disposed between the roof layer 360 and the capping layer 390. In those embodiments, the insulating layer may be made of an inorganic material such as a silicon nitride (SiNx) or a silicon oxide (SiOx).

Although not illustrated in the drawings, a polarizer may be disposed on a top surface and a bottom surface of the liquid crystal display. The polarizer may include a first polarizer attached on a bottom surface of the substrate 110 and a second polarizer attached on a top surface of the capping layer 390, and polarization axes of the first and second polarizers may be perpendicular to or parallel with each other.

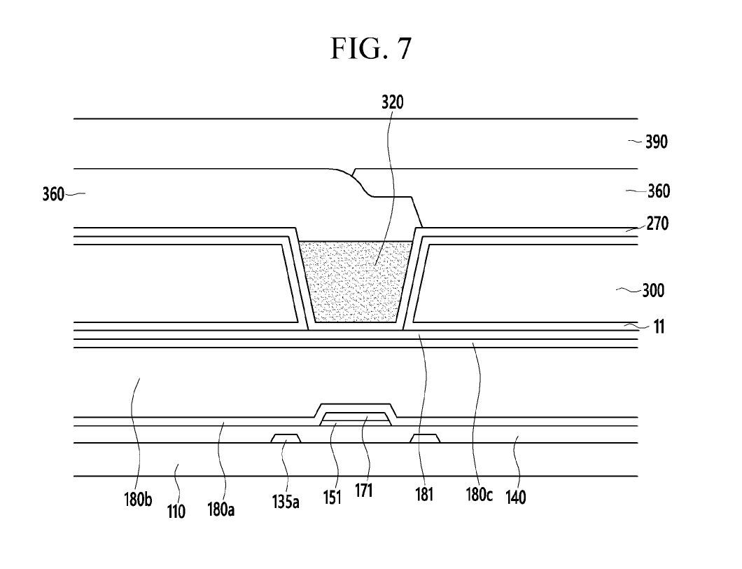

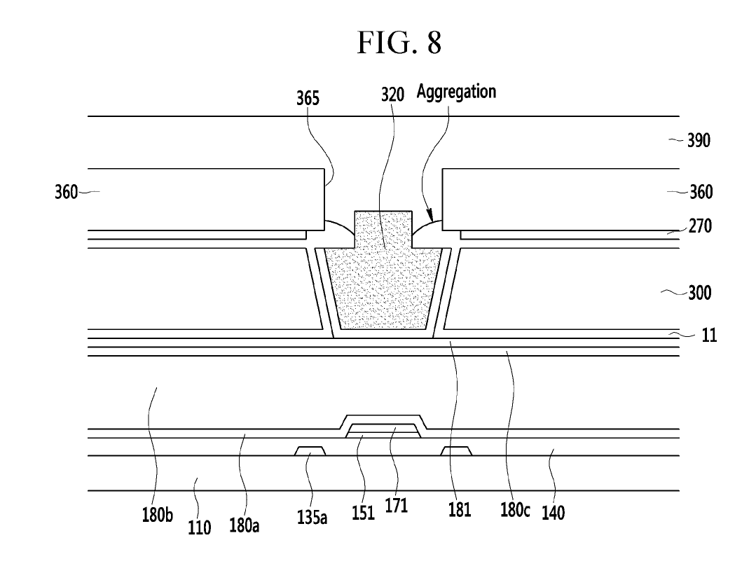

Next, further exemplary embodiments of the inventive concept will be described with reference to FIGS. 7 and 8.

FIG. 7 is a cross-sectional view of a display device according to another exemplary embodiment, corresponding to a cross-section similar to that taken along line III-III of FIG. 1. FIG. 8 is a cross-sectional view of a display device according to a further exemplary embodiment corresponding to a cross-section similar to that taken along line IV-IV of FIG. 1.

The embodiment of FIG. 7 is similar to the embodiment of FIG. 1 except for the following difference. In the embodiment of FIG. 7, the partition wall 320 is formed of a light blocking member. As a result, the partition wall 320 is made of a material that is different from the roof layer 360 which is formed of a color filter. For example, the partition wall 320 may be formed of the same material as the light blocking member. Accordingly, light leakage or light reflection may be more effectively prevented compared to the case in which the partition wall 320 is formed of the color filter. When the partition wall 320 is made of a material that is different from the roof layer 360, the common electrode 270 may be formed between the partition wall 320 and the roof layer 360 instead of below the partition wall 320. Accordingly, a distance between the common electrode 270 and the data line 171 is increased, and thus the capacitance generated therebetween is reduced, thereby decreasing RC delay.

Referring to the embodiment of FIG. 8, a top surface of the partition wall 320 is formed having an uneven shape instead of a flat shape. In contrast, in the embodiment of FIG. 4, the partition wall 320 disposed below the opening 365 of the roof layer 360 has a flat top surface. Specifically, in the embodiment of FIG. 8, the partition wall 320 includes a top surface in which a central portion protrudes from a peripheral portion. Furthermore, a width of the opening 365 is narrower in the embodiment of FIG. 8 compared to the embodiment of FIG. 4. In the embodiment of FIG. 8, a distance between an edge of the opening 365 and a protrusion of the partition wall 320 can be reduced, and as a result a strong capillary force is applied to an upper side of the partition wall 320. Accordingly, the aggregation of the alignment layer forming material can be controlled such that the aggregation of the alignment layer forming material is generated above the partition wall 320. As a result, the aggregation of the alignment layer forming material can be generated at an outer circumference of the pixel area.

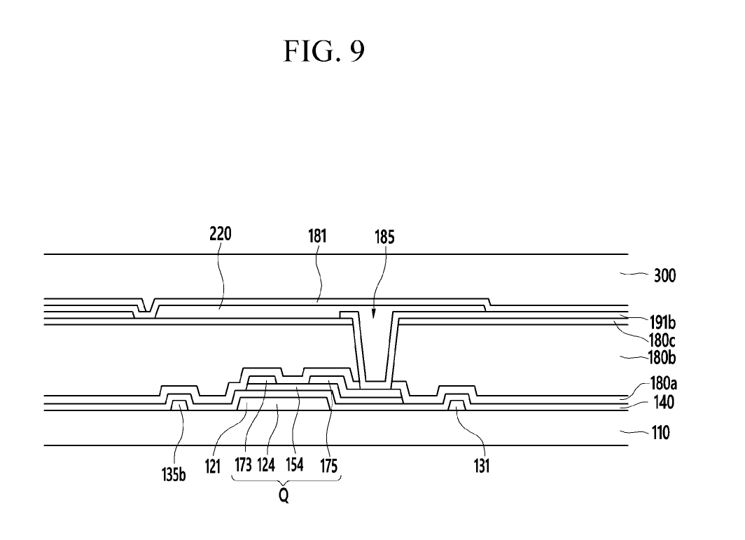

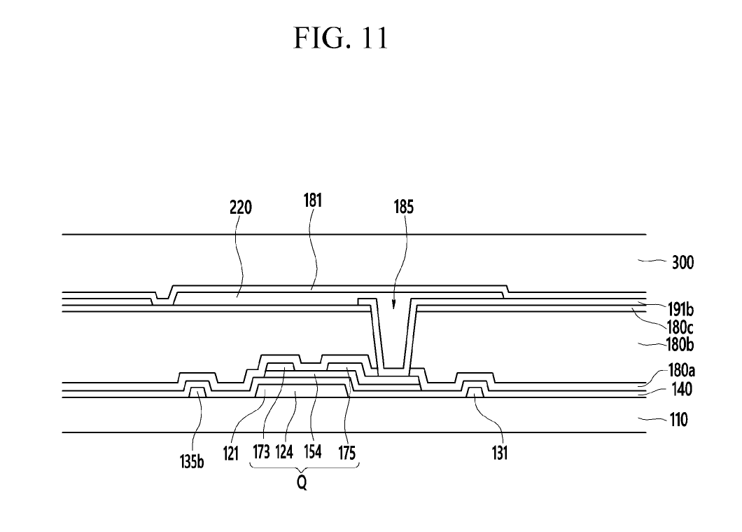

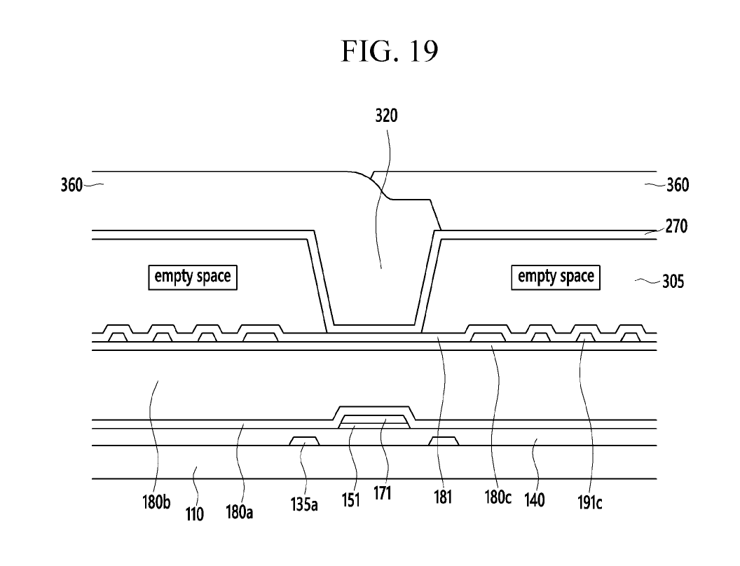

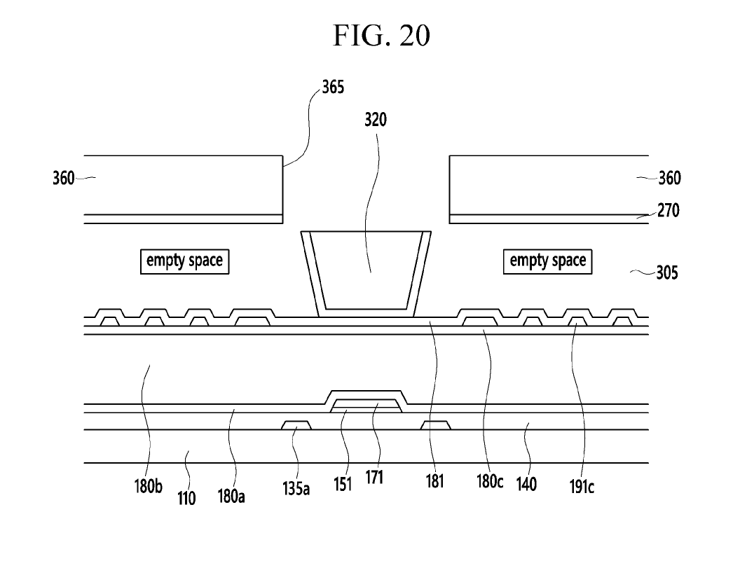

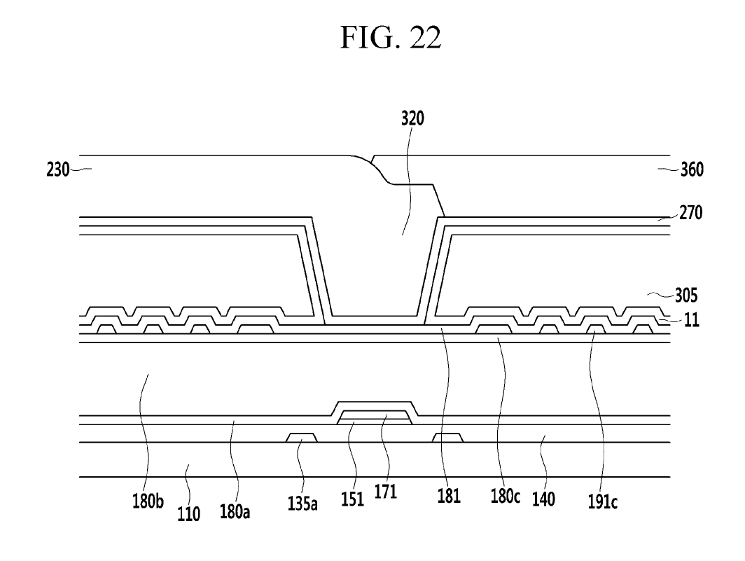

Next, a method for manufacturing a display device according to an embodiment will be described with reference to FIGS. 9 through 23.

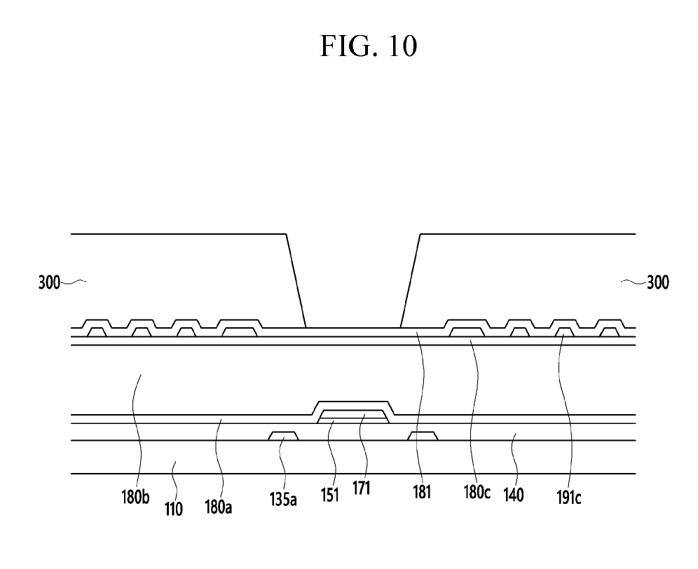

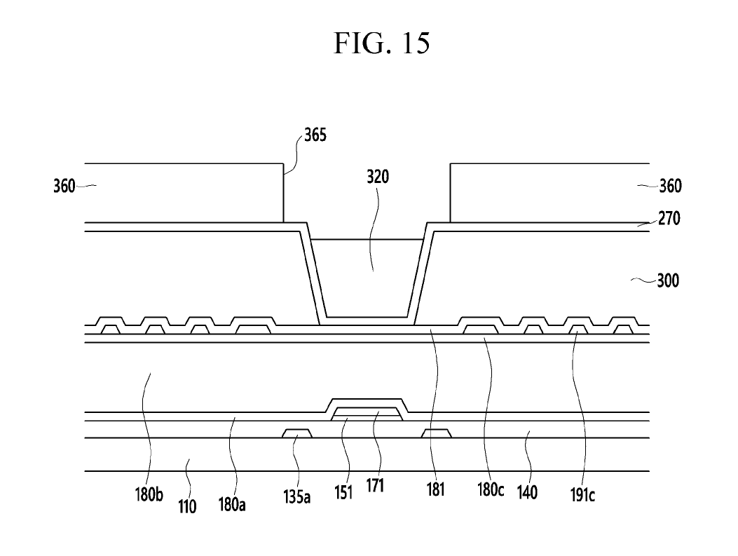

FIGS. 9, 10, 11, 12, 13, 14, 15, 16, 17, 18, 19, 20, 21, 22, and 23 are cross-sectional views of a liquid crystal display at different stages of manufacture according to the exemplary method. Specifically, FIGS. 9, 11, 13, 16, 18, and 21 illustrate the cross-sectional views at sequential stages of manufacture taken along line II-II of FIG. 1. FIGS. 10, 12, 14, 19, and 22 illustrate the cross-sectional views at sequential stages of manufacture taken along line III-III of FIG. 1. FIGS. 15, 17, 20, and 23 illustrate the cross-sectional views at sequential stages of manufacture taken along line IV-IV of FIG. 1.

Referring to FIGS. 1, 9, and 10, a switching element is formed on a substrate 110. Specifically, the gate line 121 is formed extending in the horizontal direction, the gate insulating layer 140 is formed on the gate line 121, the semiconductor layers 151 and 154 are formed on the gate insulating layer 140, and the source electrode 173 and the drain electrode 175 are formed. The data line 171 is connected to the source electrode 173, and may be formed extending in the vertical direction while crossing the gate line 121.

The first interlayer insulating layer 180a is formed on the data conductors 171, 173, and 175, and the exposed portion of the semiconductor layer 154. The data conductors 171, 173, and 175 include the source electrode 173, the drain electrode 175, and the data line 171.

The second interlayer insulating layer 180b and the third interlayer insulating layer 180c are formed on the first interlayer insulating layer 180a. The contact hole 185 is formed extending through the second interlayer insulating layer 180b and the third interlayer insulating layer 180c. Next, the pixel electrode 191 is formed on the third interlayer insulating layer 180c. The pixel electrode 191 may be electrically and physically connected to the drain electrode 175 through the contact hole 185.

The light blocking member 220 is formed on the pixel electrode 191 or the third interlayer insulating layer 180c. The light blocking member 220 may be formed along the direction in which the gate line 121 extends. The light blocking member 220 may be formed of the light blocking material. The insulating layer 181 is formed on the light blocking member 220. The insulating layer 181 may extend onto the pixel electrode 191 while covering the light blocking member 220.

Next, a sacrificial layer 300 is formed on the pixel electrode 191. A disconnected portion is formed in the sacrificial layer 300 along the direction parallel to the data line 171. In the disconnected portion, the color filter 230 may be filled to form the partition wall 320. The sacrificial layer 300 may be formed of a photoresist or an organic material.

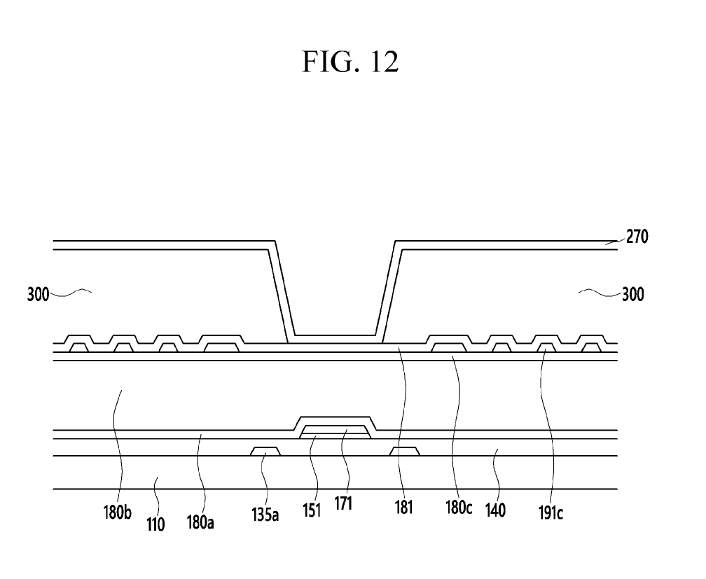

Referring to FIGS. 1, 11, and 12, the common electrode 270 is formed on the sacrificial layer 300. As shown in FIG. 12, the common electrode 270 may cover the disconnected portion of the sacrificial layer 300. According to another exemplary embodiment, an insulating layer (not shown) may be formed on the common electrode 270.

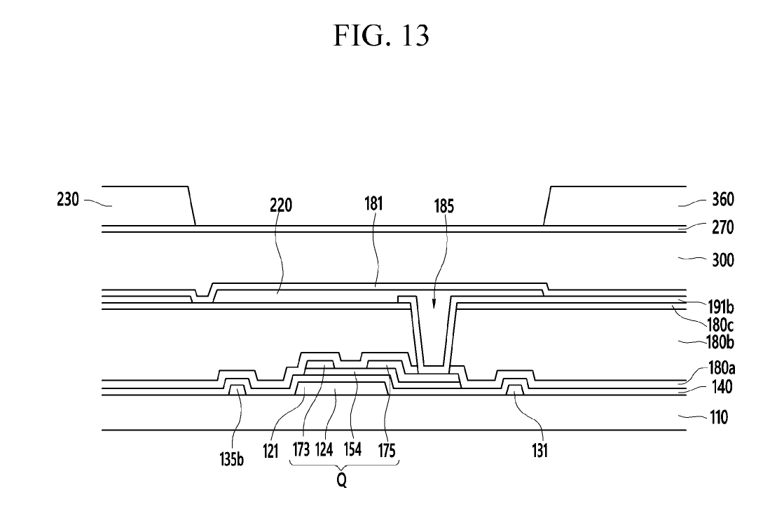

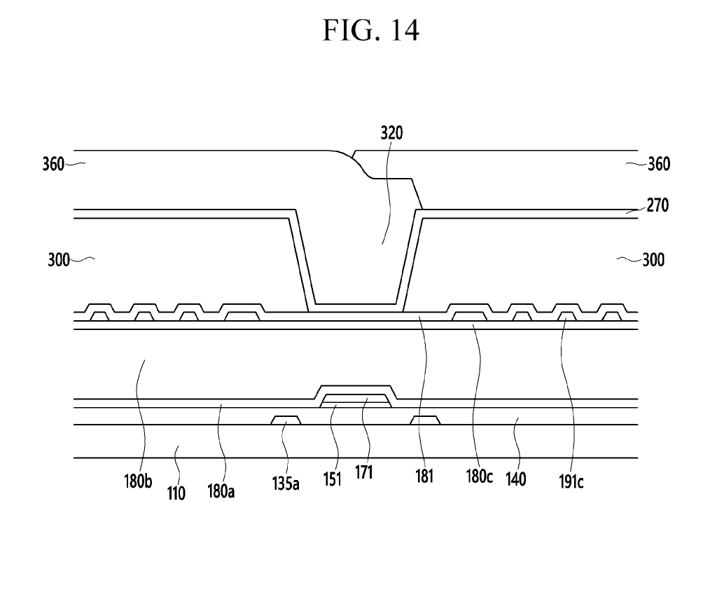

Referring to FIGS. 1, 13, 14, and 15, the roof layer 360 may be formed on the common electrode 270 using a color filter. As shown in FIG. 13, the roof layer 360 exposes the common electrode 270 to the outside at a region corresponding to the light blocking member 220. As shown in FIG. 14, the color filters constitute the partition wall 320 while filling the disconnected portion of the sacrificial layer 300. The partition wall 320 may be formed using the color filter of one color. The color filter constituting the partition wall 320 and a color filter adjacent thereto may overlap with or be separated from each other on the partition wall 320. In some embodiments, the partition wall 320 may be formed using a color filter of two colors.

The roof layer 360 may be removed in the region corresponding to the light blocking member 220 positioned between the pixel areas that are adjacent in the vertical direction (so as to correspond to the injection hole formation region 307FP). The roof layer 360 may be removed by a patterning process or an exposure/developing process. As shown in FIG. 15, the roof layer 360 can be removed at the region corresponding to the opening 365 while leaving behind the partition wall 320, for example, by using a photosensitive film pattern having different thicknesses. As a result, the opening 365 is formed partially exposing the common electrode 270. According to another exemplary embodiment, an insulating layer (not shown) may be formed on the roof layer 360 and the partition wall 320. In another exemplary embodiment in which the common electrode 270 is formed at a lower portion of the microcavity 305, the sacrificial layer 300 may be partially exposed through the opening 365.

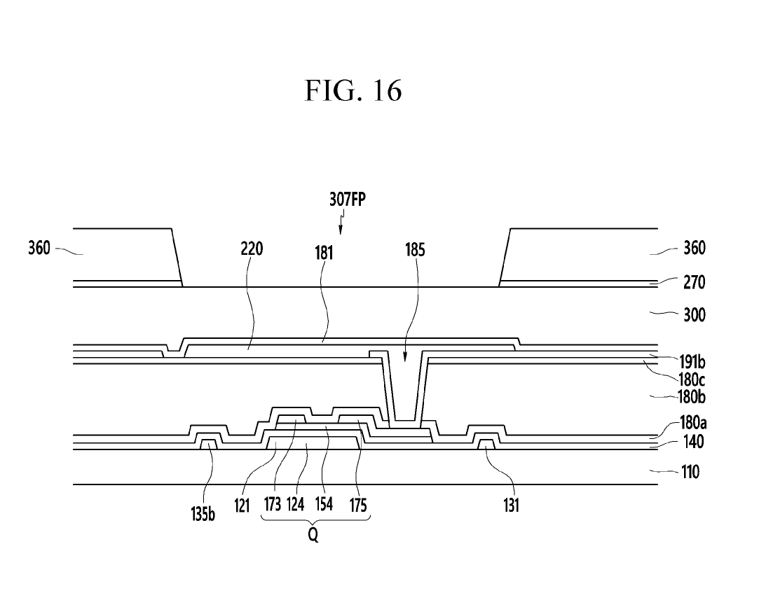

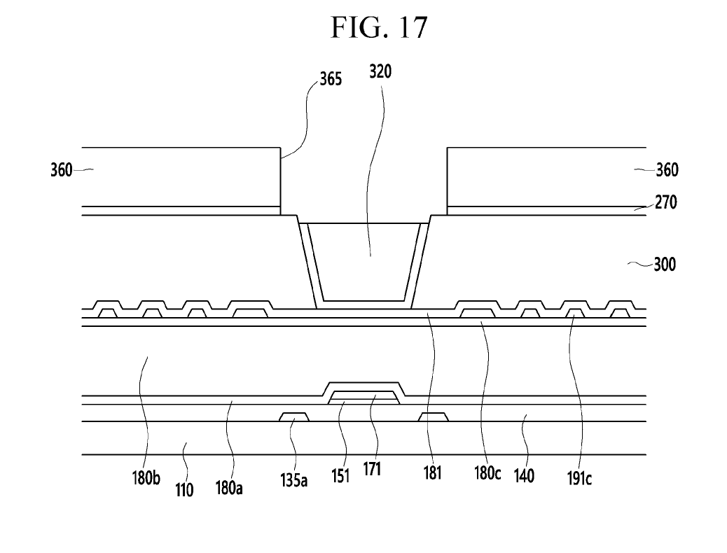

Referring to FIG. 16, the common electrode 270 is etched and thus partially removed to form the liquid crystal injection hole formation region 307FP. The common electrode 270 disposed below the opening 365 is partially removed to expose a portion of the sacrificial layer 300, as shown in FIG. 17. In an embodiment in which an insulating layer is formed below and on the roof layer 360, a portion corresponding to the region at which the common electrode 270 is formed may also be removed.

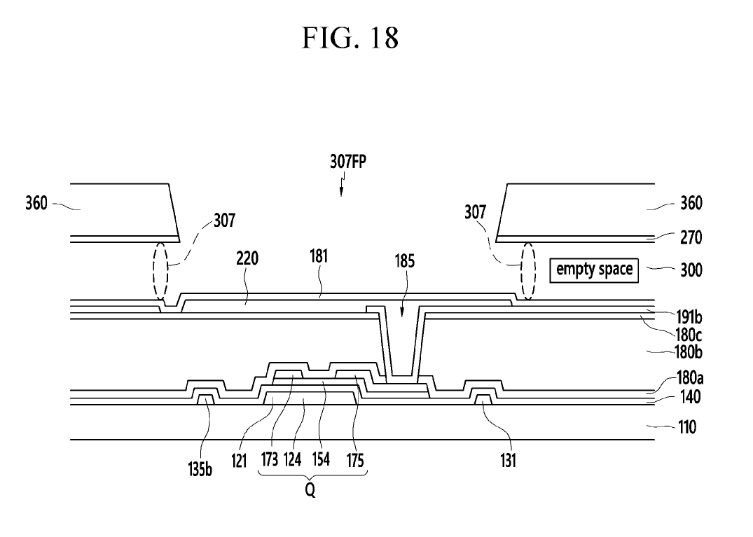

Referring to FIGS. 18, 19, and 20, the sacrificial layer 300 is removed by an oxygen (O2) ashing process or a wet-etching method through the liquid crystal injection hole formation region 307FP. Accordingly, the microcavity 305 having the liquid crystal injection hole 307 is formed. The microcavity 305 is an empty space that is formed when the sacrificial layer 300 is removed. An upper edge portion of the microcavity 305 is connected to the opening 365.

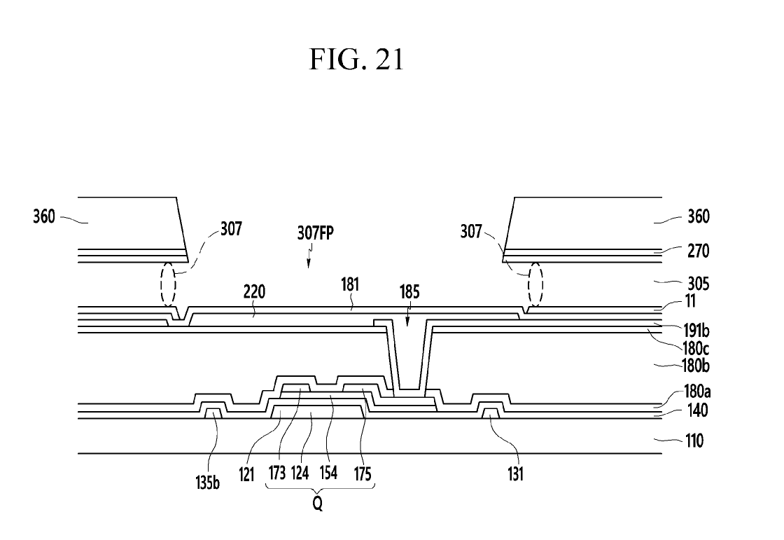

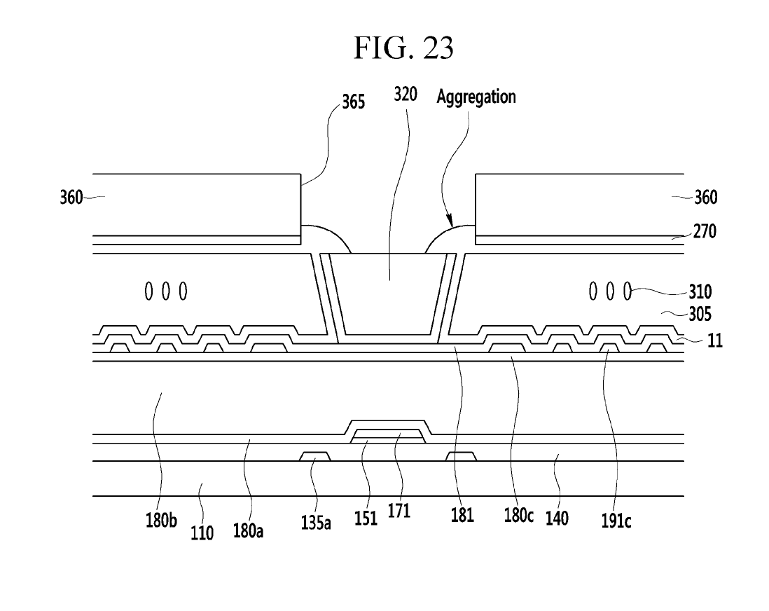

Referring to FIGS. 21, 22, and 23, an alignment layer forming material is injected through the liquid crystal injection hole 307, so as to form the alignment layer 11 within the microcavity 305 covering the pixel electrode 191 and the common electrode 270. A solution including the alignment layer forming material may be dispensed using an inkjet method or a spin coating method. As a result, the solution is injected into the microcavity 305 through capillary force. The solution is then subjected to a bake process to evaporate the solvent components of the solution other than the alignment layer forming material. The alignment layer forming material remains within the microcavity 305 to form the alignment layer 11. During the dry process, the aggregation of the alignment layer forming material is controlled such that the aggregation is generated in the opening 365 by a relatively large capillary force. As a result, the aggregation is generated around the opening 365 or within the opening 365, as illustrated in FIG. 23.

After the alignment layer 11 is formed, a liquid crystal containing liquid crystal molecules 310 is injected into the microcavity 305 through the liquid crystal injection hole 307 using, for example, an inkjet method. When the liquid crystal is injected into the microcavity 305, the opening 365 may not be completely filled by the alignment layer forming material. As such, air that is confined within the microcavity 305 can escape through the opening 365, and thus no bubbles are generated in the liquid crystal layer within the microcavity 305.

Next, the capping layer 390 is formed on the roof layer 360 covering the liquid crystal injection hole 307 and the liquid crystal injection hole formation region 307FP. Accordingly, the liquid crystal display illustrated in FIGS. 2, 3, and 4 can be manufactured using the above exemplary method.

While the inventive concept has been described in connection with what is presently considered to be exemplary embodiments, it is to be understood that the inventive concept is not limited to the disclosed embodiments, but, on the contrary, is intended to cover various modifications and equivalent arrangements included within the spirit and scope of the appended claims.

What is claimed is:

1. A liquid crystal display comprising:
a substrate;
a thin film transistor disposed on the substrate;
a pixel electrode disposed on the thin film transistor and connected to the thin film transistor;
an alignment layer disposed on the pixel electrode and within a microcavity having an injection hole;
a liquid crystal layer disposed within the microcavity; and
a roof layer disposed on the microcavity, the roof layer having an opening.

2. The liquid crystal display of claim 1, wherein the alignment layer is formed from an alignment layer forming material, and wherein the alignment layer forming material aggregates on at least a portion of the opening.

3. The liquid crystal display of claim 1, further comprising:
a partition wall disposed between adjacent microcavities,
wherein the opening is adjacent to the partition wall.

4. The liquid crystal display of claim 3, wherein the opening overlaps with the partition wall.

5. The liquid crystal display of claim 4, wherein the opening is connected to two adjacent microcavities.

6. The liquid crystal display of claim 5, wherein a top surface of the partition wall that overlaps with the opening has a flat shape.

7. The liquid crystal display of claim 5, wherein a top surface of the partition wall that overlaps with the opening has an uneven shape.

8. The liquid crystal display of claim 1, further comprising:
a common electrode configured to generate an electric field together with the pixel electrode.

9. The liquid crystal display of claim 8, wherein the common electrode is disposed between the microcavity and the roof layer.

10. The liquid crystal display of claim 8, wherein the common electrode is disposed above or below the pixel electrode, with an insulating layer disposed therebetween.

11. The liquid crystal display of claim 1, wherein the roof layer includes a plurality of openings for one microcavity.

12. The liquid crystal display of claim 3, wherein an alignment layer forming material is disposed on the partition wall.

13. The liquid crystal display of claim 3, wherein the partition wall includes a light blocking member.

14. The liquid crystal display of claim 3, wherein the partition wall includes a color filter.

15. The liquid crystal display of claim 1, wherein the roof layer includes a color filter.

16. The liquid crystal display of claim 3, further comprising:
a capping layer disposed on the roof layer.

17. The liquid crystal display of claim 16, wherein the alignment layer is formed from an alignment layer forming material, the alignment layer forming material aggregates on at least a portion of the opening, and
the capping layer contacts the alignment layer forming material.

18. The liquid crystal display of claim 16, wherein the capping layer contacts the partition wall.
